(19) United States
(12) Patent Application Publication
(10) Pub. No.: US 2018/0195432 A1
(43) Pub. Date: Jul. 12, 2018

(54) EXHAUST-GAS TURBOCHARGER HAVING A WASTEGATE DEVICE

(71) Applicant: CONTINENTAL AUTOMOTIVE GMBH, Hannover (DE)

(72) Inventors: Christoph Sparrer, Regensburg (DE); Georg Mehne, Wenzenbach (DE)

(73) Assignee: CONTINENTAL AUTOMOTIVE GMBH, Hannover (DE)

(21) Appl. No.: 15/738,402

(22) PCT Filed: Jun. 2, 2016
(86) PCT No.: PCT/EP2016/062546

§ 371 Date: Dec. 20, 2017

(30) Foreign Application Priority Data
Jul. 2, 2015 (DE) 10 2015 212 381.2

(51) Int. Cl. F02B 37/18; F01D 17/10; F16K 1/20

(52) U.S. Cl. CPC F02B 37/186; F05D 2220/40; F16K 1/2014; F01D 17/105

(57) ABSTRACT

The invention relates to an exhaust-gas turbocharger for an internal combustion engine (1), having a turbine (2), having a compressor wheel (4), which is connected to said turbine by means of a shaft, and having a wastegate device (8), which wastegate device has a wastegate actuator (5), has a wastegate drive shaft (7) rotatable about an axis of rotation (6), and has a flap (20a, 20b, 20c, 20d, 20e, 20f, 20g) which is fastened to said drive shaft and which is pivotable about the axis of rotation and which has a covering surface (9) for potentially opening up and closing off a wastegate opening (10a), wherein the wastegate flap and the wastegate opening (10a) that can be closed off by means of said wastegate flap are designed in such a way that the distance between the center of area (11, 1a) of the covering surface (9), which covers the wastegate opening, of the wastegate flap and the axis of rotation (6) is smaller than the radius of a circular surface of equal surface area.

The invention is within the field of mechanical engineering and can be used with particular advantage in automotive engineering. More specifically, the invention relates to an exhaust-gas turbocharger.

To increase the utilization of the fuel and to boost power and ensure economical and environmentally friendly operation, many modern internal combustion engines have an exhaust-gas turbocharger. A turbocharger of this kind has, in the exhaust gas flow of the internal combustion engine, a turbine that can be driven by this exhaust gas flow and a compressor, which is arranged in the induced gas flow and which compresses the induced air fed to the internal combustion engine. The exhaust-gas turbine and the compressor are connected to one another by means of a shaft, with the result that the turbine drives the compressor wheel.

For improved control of the exhaust gas flow, a wastegate opening is provided from the exhaust side of the internal combustion engine, in the region of the turbine, which wastegate opening provides a bypass channel for the exhaust gas flow and can be closed in a controlled manner by means of a wastegate flap. Depending on the operating conditions, the exhaust gas flow can thereby be fed in whole or in part to the turbine of the turbocharger. Control of the wastegate flap is usually accomplished mechanically by means of a control rod, which can be driven by an actuator. By means of a lever, the control rod usually drives a wastegate spindle or wastegate shaft, on which the wastegate flap is secured within the turbocharger device.

An important requirement of the wastegate system is that the wastegate flap can be closed and held closed reliably against the exhaust gas pressure. Compliance with this requirement depends essentially on the balance of forces acting on the wastegate flap. Said wastegate flap is acted upon, on the one hand, by the exhaust gas pressure and, on the other hand, by the contact pressure provided by the torque of the shaft. For reliable and firm closing of the flap, it is necessary that the force acting on the flap via the shaft is greater than the exhaust-gas force. To increase the contact force, either the chosen driving lever of the wastegate shaft outside the turbine casing can be particularly large and/or the chosen distance between the wastegate flap and the axis of rotation can be as small as possible.

Accordingly, it is the underlying object of the present invention to configure an exhaust-gas turbocharger of the type stated at the outset in such a way that the contact pressure on the wastegate flap becomes as large as possible.

The object is achieved by means of the features of the invention in accordance with patent claim 1.

Accordingly, the invention relates to an exhaust-gas turbocharger for an internal combustion engine, having a turbine, having a compressor wheel, which is connected to said turbine by means of a shaft, and having a wastegate device, which wastegate device has a wastegate actuator, has a wastegate drive shaft rotatable about an axis of rotation, and has a flap, which is fastened to said drive shaft and which is pivotable about the axis of rotation and which has a covering surface for potentially opening up and closing off a wastegate opening, wherein the wastegate flap and the wastegate opening that can be closed off by means of said wastegate flap are designed in such a way that the distance between the center of area of the covering surface, which covers the wastegate opening, of the wastegate flap and the axis of rotation is smaller than the radius of a circular surface of equal surface area.

The contact pressure of the wastegate flap on the wastegate opening or on the sealing edge of the opening depends on the average distance between the sealing edge of the wastegate flap forming the boundary edge of the covering surface and the axis of rotation. This quantity can be described by the position of the center of area relative to the axis of rotation. For example, the center of area of the covering surface of the wastegate flap can move closer to the axis of rotation if the covering surface is extended in length parallel to the axis of rotation and compressed transversely to the axis of rotation, starting from a constant size of the covering surface. Given a constant size of the opening or covering surface, the contact pressure of the wastegate flap on the wastegate opening can therefore be increased by means of the stated shaping of the covering surface.

A particularly advantageous possibility here is to provide for the wastegate flap and the wastegate opening that can be closed by said flap to be designed in such a way that the minimum distance between the covering surface and the axis of rotation is as small as possible.

In the case of a circular configuration of the covering surface of the wastegate flap, this is advantageously spaced apart from the axis of rotation to such an extent that the minimum distance between the covering surface and the axis of rotation corresponds to the magnitude of a tolerance, with the result that, even when the tolerance is fully exhausted, the entire covering surface is on one side of the axis of rotation and the wastegate opening can be fully opened when the wastegate flap is swung open.

The invention can furthermore advantageously provide for the covering surface to have at least one straight edge, which is, in particular, parallel to the axis of rotation or encloses with the latter an angle which is less than 10 degrees. Such an edge can form the covering-surface lateral edge facing the axis of rotation, for example, or can form the side facing away from the axis of rotation.

It is also advantageously possible to provide for the covering surface to have at least two straight edges, wherein the two edges are, in particular, parallel to one another or enclose between them an angle which is less than 10 degrees.

The covering surface can be irregularly shaped but bounded by straight lines or irregularly shaped and bounded by irregular lines. For example, it can have an edge on the side facing the axis of rotation which is substantially parallel to the axis of rotation and a parallel edge on the covering-surface side facing away from the axis of rotation. If the covering surface has an edge which is straight and parallel to the axis of rotation on its side facing the axis of rotation, then, according to plan, this edge should be spaced apart from the axis of rotation by at least the tolerance spacing.

The covering surface can be of triangular, rectangular, trapezoidal, elliptical or diamond shape. In the case of an elliptical or diamond shape, this should be extended parallel to the axis of rotation and compressed perpendicularly thereto. For example, the covering surface can be of mirror-symmetrical configuration relative to an axis perpendicular to the axis of rotation. The corresponding sealing surface at the wastegate opening should then have a corresponding shape in each case.

Provision can furthermore advantageously be made for the sealing surface of the flap, said sealing surface surrounding the covering surface, to be flat and parallel to the plane of the sealing surface.

This makes possible secure and reliable sealing of the covering flap under the influence of the contact force, even against a gas pressure.

Another advantageous embodiment of the invention envisages that the sealing surface of the flap, said sealing surface surrounding the covering surface, slopes relative to the covering surface.

If the sealing surface slopes relative to the covering surface at the covering surface, centering of the wastegate flap on the wastegate opening can be achieved by means of the transverse forces which act during the closure of the flap, and therefore better sealing and hence better efficiency of the exhaust-gas turbocharger can be achieved. In this case, all the regions of the sealing surface around the covering surface can either all have the same slope toward the inside of the covering surface or all have the same slope outward away from the covering surface.

The invention can also advantageously be configured in such a way that the sealing surface of the flap, said sealing surface surrounding the covering surface, is of conical or spherical-cap-shaped design. A conical or spherical-cap configuration of the sealing surface around the covering surface allows particularly efficient sealing and centering of the wastegate flap in the wastegate opening.

Provision can furthermore advantageously be made for the covering surface to have a projection which extends into the wastegate opening during closure. The provision of such a projection facilitates guidance of the flow during the opening of the flap and the configuration of a free channel when the wastegate flap is open.

Provision can furthermore advantageously be made for the thickness of the projection to increase with increasing distance from the axis of rotation, starting from the region of the wastegate flap which is closest to the axis of rotation. By means of such a configuration of the projection on the wastegate flap, it is ensured that the projection does not constitute an obstruction at the edge of the wastegate opening in that region of the wastegate flap which is close to the axis of rotation, especially at the beginning of the opening movement or at the end of the closing movement.

In the following part of the document, the invention is illustrated in figures of a drawing by means of illustrative embodiments and then explained. In the drawing:

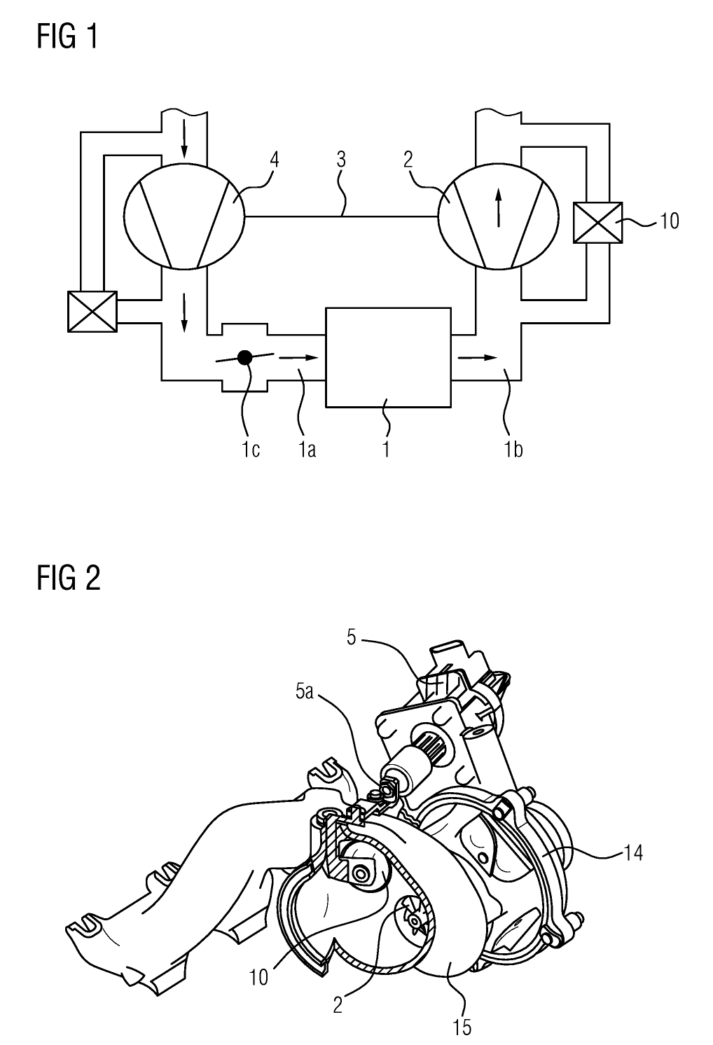

FIG. 1 shows a schematic illustration of the functional elements of an exhaust-gas turbocharger,

FIG. 2 shows a perspective view of an exhaust-gas turbocharger in partial section,

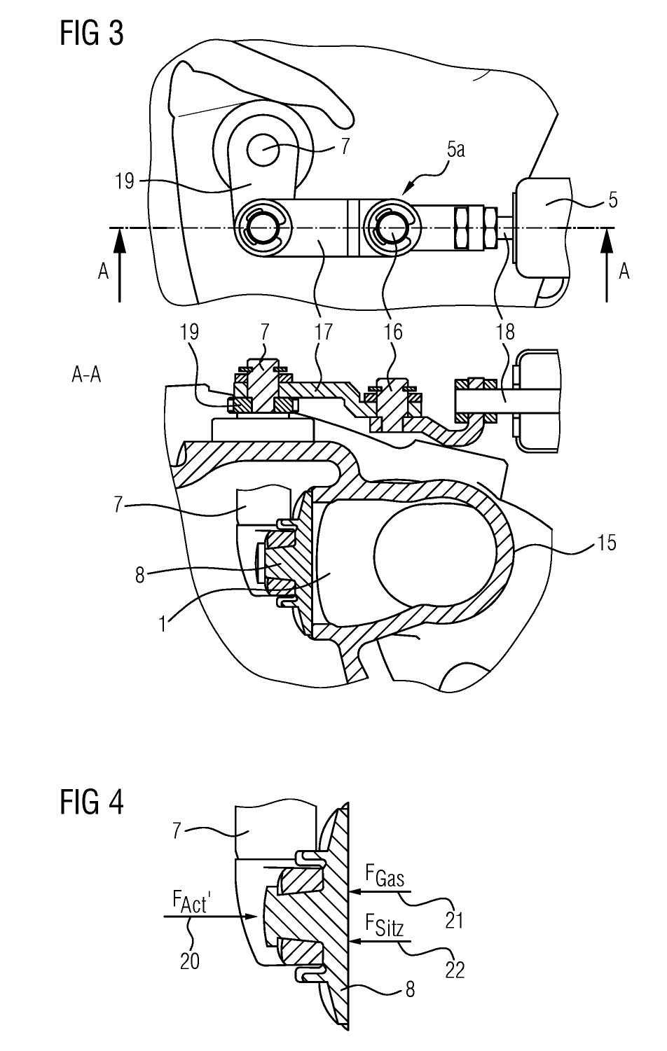

FIG. 3 shows a view of the control rod of the exhaust-gas turbocharger in the upper area of the illustration, while a section along the line A-A in the upper part is illustrated in the lower area,

FIG. 4 shows a partially sectioned illustration of the wastegate flap with the drive shaft thereof,

FIG. 5 shows a schematic illustration of the wastegate flap with the drive shaft thereof,

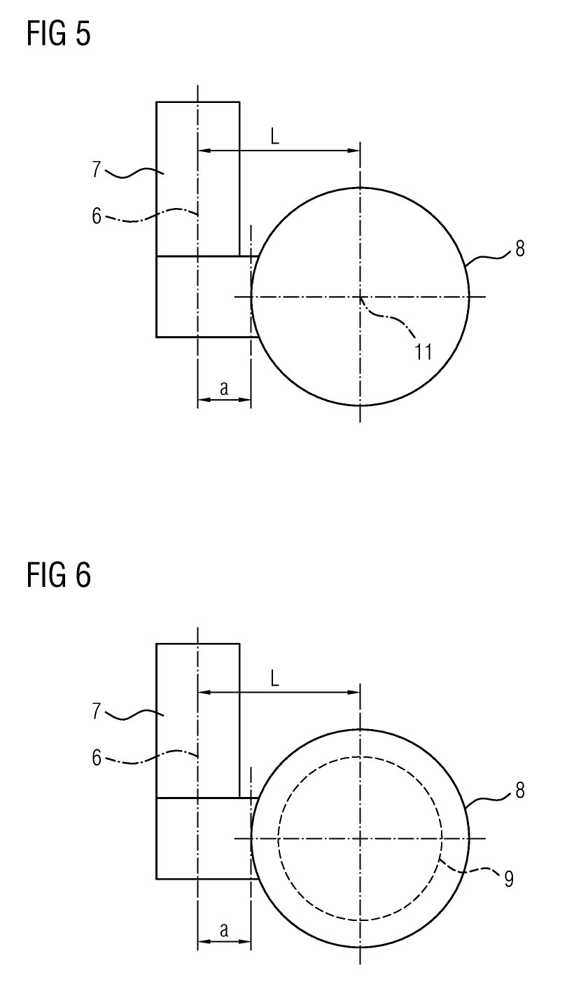

FIG. 6 shows another schematic illustration of the wastegate flap,

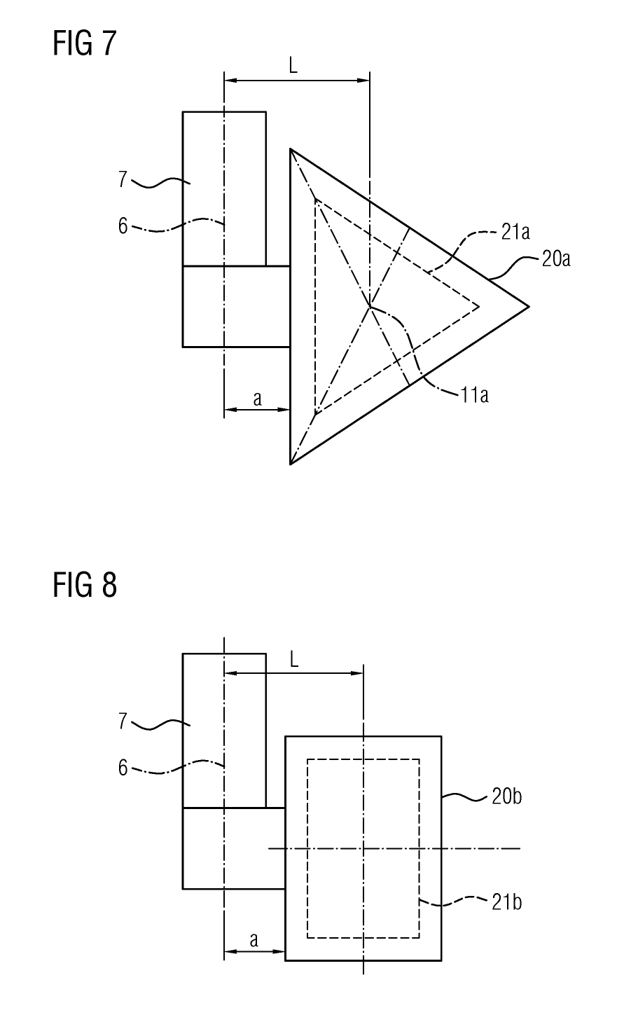

FIG. 7 shows a schematic illustration of a wastegate flap in triangular form,

FIG. 8 shows a schematic illustration of a wastegate flap in rectangular form,

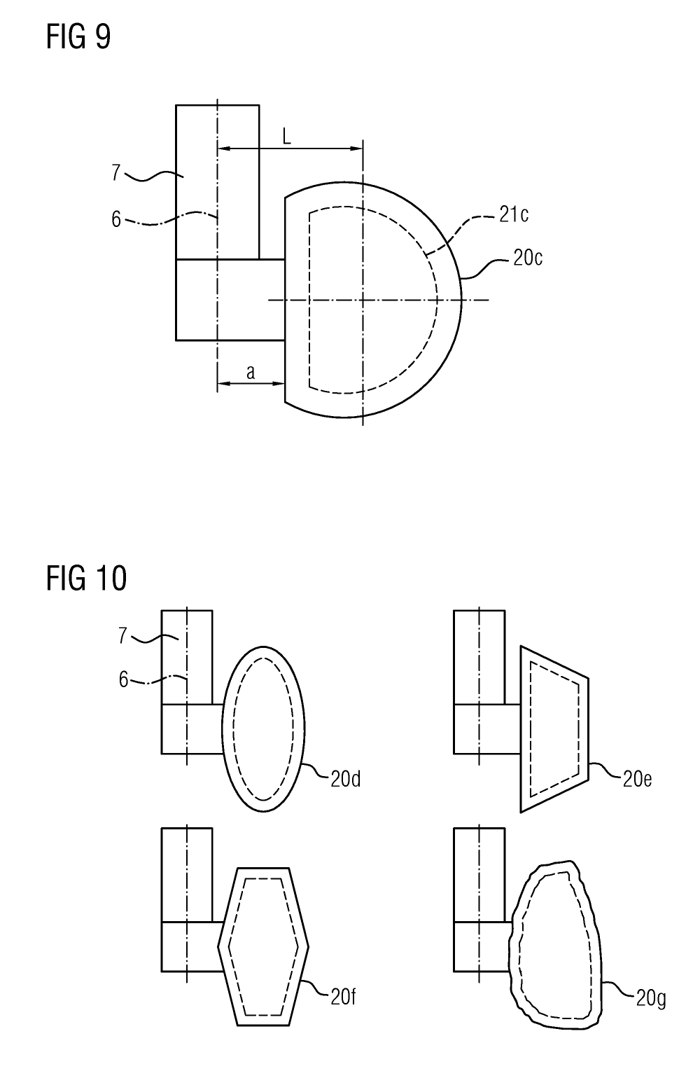

FIG. 9 shows a schematic illustration of a wastegate flap in a flattened partially circular form,

FIG. 10 shows the illustration of four further geometrical shapes of wastegate flaps,

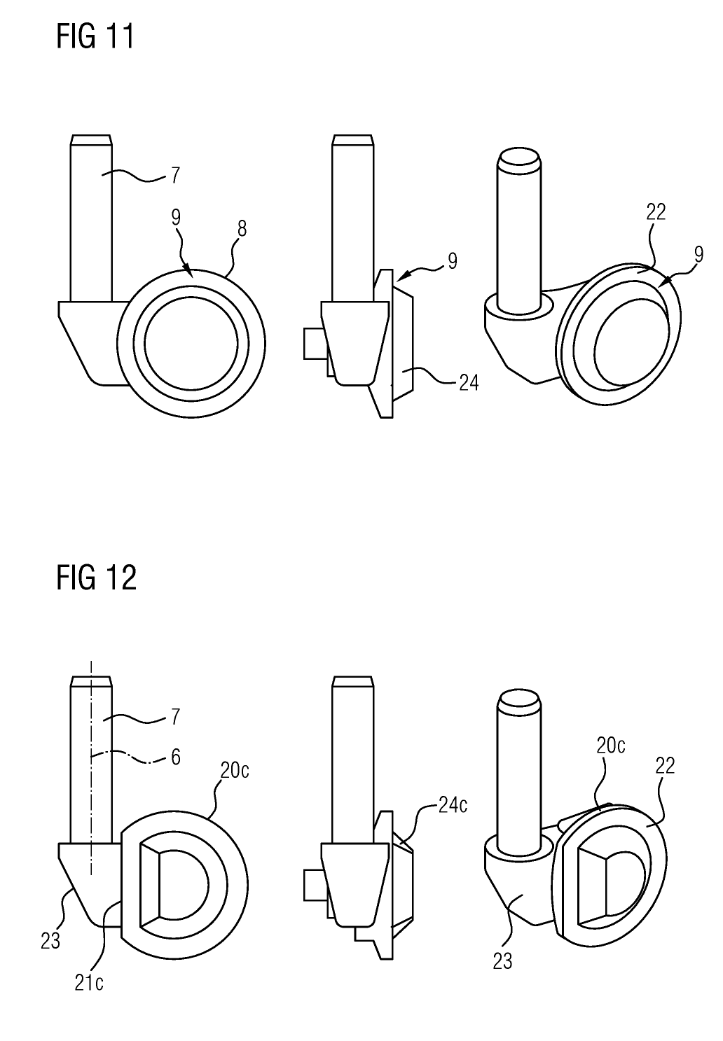

FIG. 11 shows three views of a round wastegate flap in various perspectives,

FIG. 12 shows three views of another wastegate flap in various perspectives,

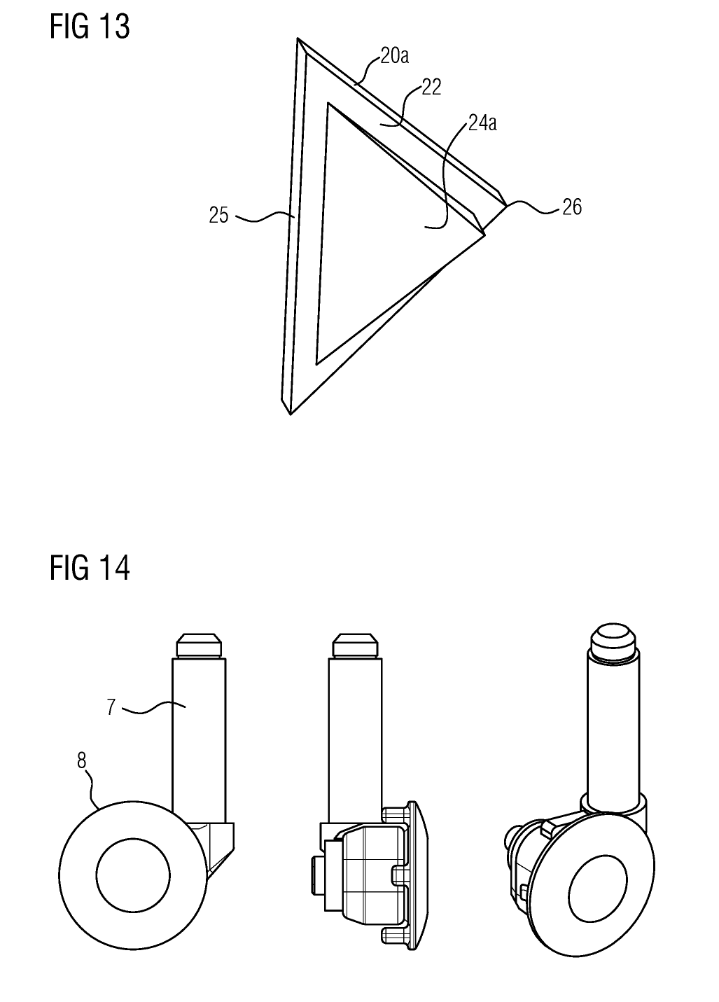

FIG. 13 shows the view of a triangular wastegate flap with a raised portion on the inner side,

FIG. 14 shows three views of a wastegate flap in the form of a circular disk with a conical sealing surface,

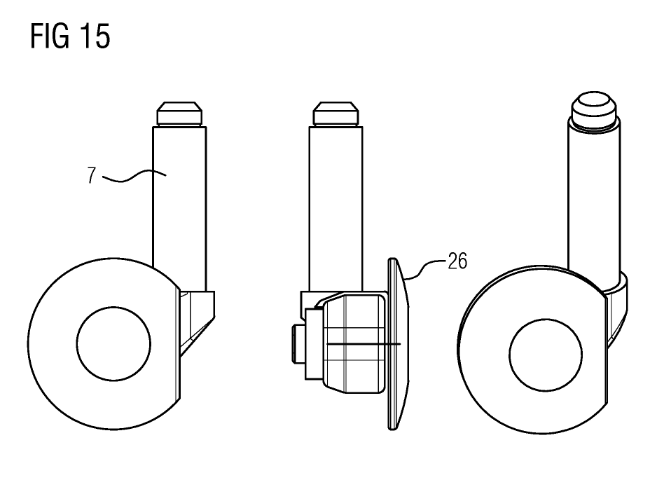

FIG. 15 shows three views of a flattened wastegate flap in the form of a partial circle with a spherical-cap-shaped sealing surface,

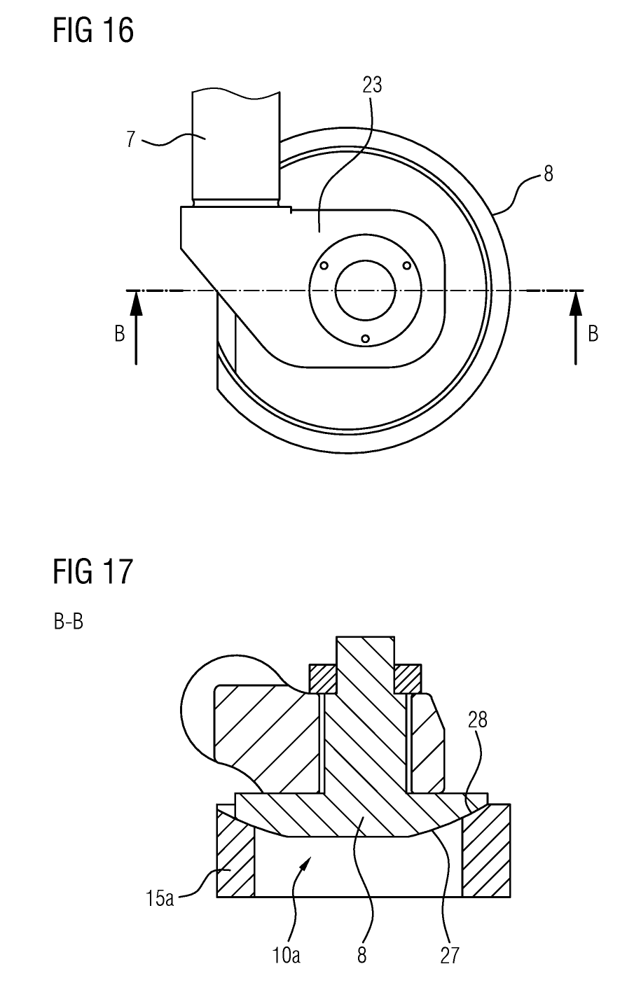

FIG. 16 shows a view of a flattened wastegate flap in the form of a partial circle with the drive shaft thereof, and

FIG. 17 shows a cross section along the line B-B in FIG. 16.

FIG. 1 illustrates schematically the elements of an exhaust-gas turbocharger. This is structurally connected to an internal combustion engine 1, which has an intake duct 1a and an exhaust duct 1b. Ambient air for combustion is drawn in through the intake duct 1a, while the combustion products heated up during the combustion process, principally in gas form, are expelled through the exhaust duct 1b.

Arranged in the exhaust duct 1b is a turbine 2, which is driven by the expelled exhaust gases. This is connected by means of a shaft 3 to a compressor wheel 4. During the operation of the turbocharger device, the compressor wheel 4 is driven in such a way that it additionally compresses the air drawn in through the intake duct 1a, with the result that compressed intake air is available for the combustion process and more fuel can be added to it per cylinder stroke, thus allowing the engine torque to be increased.

A throttle valve 1c for controlling the intake air, an air filter (not shown) ahead of the compressor wheel, as well as an air flow meter ahead of the compressor wheel and a charge air cooler downstream of the compressor wheel are provided in the intake duct 1a. Also worth mentioning is the possible arrangement of a catalytic converter in the exhaust duct 1b downstream of the turbine 2.

In the pressure-charged mode, the throttle valve 1c is fully open.

Regulation of pressure charging is possible by releasing some of the exhaust gas mass flow on the turbine side through the “wastegate” 10 with a wastegate opening, thereby opening a bypass duct which makes it possible to guide some of the exhaust gases past the turbine 2.

FIG. 2 shows, in a perspective view, the turbine casing 15, in which the wastegate device 10 is arranged. Said device is actuated by means of an electric wastegate actuator 5, which is mounted on a holder on the compressor casing 14. Between the turbine casing 15 and the compressor casing 14 there is a core group, in which the common shaft of the exhaust-gas turbine and of the compressor wheel is accommodated. The exhaust-gas turbine 2 can be seen in the foreground.

The control rod of the actuator 5 is denoted by 5a. As elements, as can be seen in FIG. 3, it has a tappet 18, which can be moved in the longitudinal direction thereof, as well as a joint 16 and an extension 17, which is coupled to the lever 19 of the wastegate drive shaft 7. The joint 16 is required to compensate for the circular movement of the lever 7 since the tappet 18 can only move axially. By means of the actuator 5, the shaft 7 can thus be driven in rotation as a drive shaft of the wastegate flap.

The section line A-A, along which a cross section is shown in the lower part of FIG. 3, is indicated in the upper half of FIG. 3. The cross section shows part of the turbine casing 15 with the wastegate flap 8 and the wastegate drive shaft 7. The tappet 18, the joint 16 and the extension 17 of the control rod 5a can also be seen in the lower part of the figure.

The force relationships between the forces acting on the wastegate flap 8 are illustrated in FIG. 4. Acting in the direction of arrow 20 there is first of all the actuating force 20, which is transmitted to the flap 8 by the control rod 5a and the drive shaft 7. Acting as counter forces there are force 21, which is produced by the gas pressure in the wastegate device, and force 22, which forms the pressing force on the seal seat of the wastegate opening. If the force on the seal seat is to be as large as possible, it would seem advisable to maximize the force transmitted to the flap by the drive shaft.

For this purpose, as can easily be seen in FIG. 5, it is particularly advantageous if the load arm L between the center of area 11 and the axis of rotation 6 of the drive shaft 7 is as short as possible. For this purpose, it is advisable to position the covering surface of the wastegate flap 8 as close as possible to the axis of rotation 6. This gives rise to a large torque on the flap, thereby making it possible to produce a large contact force on the seal seat. At the same time, however, it should be taken into account that, in some cases, the flap 8 should be at a minimum distance from the axis of rotation 6, in the form of tolerance length a, in order to compensate for tolerances. If the tolerance were not respected and the lever arm L became too short, the wastegate flap would strike against the seat on the wastegate opening before the closed flap position was reached. With modern manufacturing methods, however, the tolerance can be reduced virtually to zero.

FIG. 6 shows in greater detail that the wastegate flap 8 overall has a larger diameter than the covering surface, which is illustrated in a circle of dashed lines and is denoted by 9. The covering surface covers the wastegate opening within the sealing surface.

FIG. 7 shows an illustration according to the invention of a wastegate flap 20a, the center of area 11a of which is positioned closer to the axis of rotation 6 in comparison with a circular configuration of the covering surface, while the surface area is the same. This is accomplished by means of a triangular configuration, wherein the triangle is configured in such a way that a straight edge 21a runs parallel to the axis of rotation 6. According to the rules of geometry, the center of area is arranged at one third of the height of the triangle in relation to the edge 21a, as viewed from the axis of rotation 6.

FIG. 8 shows a rectangular wastegate flap 20b, on which an edge 21b of the covering surface is arranged parallel to the axis of rotation 6. The rectangle 20b and the corresponding covering surface are extended in a direction parallel to the axis of rotation 6 and compressed perpendicularly thereto.

FIG. 9 shows a wastegate flap 20c in a flattened circular shape, wherein an edge 21c of the covering surface, once again illustrated in dashed lines here, is parallel to the axis of rotation 6 on the side facing the latter. The covering surface of this wastegate flap 20c is comparable in respect of surface area to a circular wastegate flap with a circular covering surface of smaller diameter. By virtue of the flat in the region of edge 21c, the wastegate flap 20c and hence also the covering surface can be positioned closer to the axis of rotation 6 while being of the same size, and therefore a higher contact force of the flap 20c on the seat of the wastegate opening can be achieved for the same torque of the shaft 7. The illustrated flattened configuration of the wastegate flap 20c is extended in a direction parallel to the axis of rotation 6 and compressed transversely thereto in comparison with a corresponding circular shape.

FIG. 10 shows four further configurations of wastegate flaps 20d (elliptical, wherein the long axis of the ellipse is aligned parallel to the axis of rotation 6), 20e (trapezoidal, wherein the longer side of the trapezoid faces the axis of rotation), 20f (diamond-shaped, wherein the long axis of the diamond is aligned parallel to the axis of rotation) and 20g (irregularly shaped with a configuration which is extended in the direction of the axis of rotation 6 in comparison with a circular surface). Other geometrical shapes of wastegate flaps with corresponding covering surfaces are conceivable within the scope of the invention.

FIG. 11 shows a drive shaft 7 for a wastegate flap 8 in three different perspective views, said flap having a circular covering surface 9. The circular shaping does not correspond to the shape envisaged according to the invention but this example is a simple means of illustrating the provision of a projection on the wastegate flap. The simplest example of the projection can be seen in the central illustration since it extends beyond the flat annular outer part of the sealing surface 22 of the wastegate flap disk. During the closure of the wastegate opening 10a, the projection 24 enters said opening. The projection 24 is of conical construction in order to shape the opening characteristic of the wastegate valve since this shaping ensures that a reduced cross section is available in a partially open position of the flap. In the first phase of opening, only a small flow cross section is thus initially exposed in comparison with the full pivoting angle of the wastegate flap, and this initial displacement is subsequently completed as the opening angle increases until the wastegate opening is fully exposed.

A corresponding configuration of projections 24a, 24c can also be found in FIGS. 12 and 13.

FIG. 12 shows a wastegate flap 20c in a triple perspective view, said flap being partially circular but flattened by means of the edge 21c in the region close to the axis of rotation 6. In the central illustration in FIG. 12, the conically tapering projection 24c can be seen, said projection rising above the sealing surface 22. The drive shaft 7 and the load lever 23 are furthermore illustrated in FIG. 12.

FIG. 13 shows a triangular wastegate flap 20a in a perspective illustration, said flap having a projection 24a which is constructed in the manner of a wedge from the edge 25 close to the axis of rotation of the triangular wastegate flap toward the pointed end 26. This configuration further improves the opening characteristic of the wastegate valve, i.e. of the free flow cross section relative to the opening angle of the wastegate flap. Such an oblique rise in the projection across the width of the wastegate flap can of course also be appropriate in the case of other geometries.

FIG. 14 shows a round wastegate flap 8 in a corresponding drive shaft 7 in a triple perspective view. As is clearly visible in the central view, the wastegate flap has a conical shape in the region of the valve seat, i.e. in the region of the sealing surface of the valve flap which interacts with the edge of the wastegate opening. This has the effect that the wastegate flap disk is centered automatically on the wastegate opening and that the seal between the wastegate flap and the edge of the wastegate opening is improved.

FIG. 15 shows a similar wastegate flap to that in FIG. 14 in a triple perspective view, although the contour 26 of the sealing surface of the wastegate flap is of spherical-cap-shaped construction, i.e. has a spherical curvature.

FIG. 16 once again shows a flattened circular wastegate flap 8 together with the load lever 23 and the shaft 7. In FIG. 16, B-B furthermore indicates a section which is illustrated in FIG. 17. There, the wastegate flap 8 is shown in cross section with a conical sealing surface 27, which rests against a correspondingly conically recessed wall 15a of the turbine casing 15, in which the wastegate opening 10a is provided. The edge 28 of the wastegate opening is complementary in design to the conical shape of the wastegate flap 8, giving rise to a valve seat that provides a good seal. This complementary shaping of the edge of the wastegate opening and the wastegate flap is also not restricted to circular wastegate flaps and to a conical shape but can also be provided for all the flap shapes presented.

In the end, an increased contact pressure of the wastegate flaps and hence better sealing behavior of the wastegate valve and therefore better efficiency of the exhaust-gas turbocharger and of the combustion engine can be achieved with the flap shapes shown and explained above.

1. An exhaust-gas turbocharger for an internal combustion engine, comprising a turbine, a compressor wheel connected to said turbine by a shaft, and comprising a wastegate device, the wastegate device comprising a wastegate actuator, has a wastegate drive shaft rotatable about an axis of rotation, and has a flap, the flap fastened to said drive shaft and pivotable about the axis of rotation and defining a covering surface for potentially opening up and closing off a wastegate opening, wherein at least one of the wastegate flap and the wastegate opening that may be closed off by means of said wastegate flap are configured in such a way that the distance between the center of area of the covering surface, configured to cover the wastegate opening, of the wastegate flap and the axis of rotation is smaller than the radius of a circular surface of equal surface area and the covering surface of the wastegate flap and the wastegate opening that can be closed off by means of said wastegate flap are extended in a direction parallel to the axis of rotation and compressed perpendicularly to the axis of rotation in comparison with a circular configuration of equal surface area.

2. (canceled)

3. The exhaust-gas turbocharger as claimed in claim 1, wherein the minimum distance between the covering surface and the axis of rotation amounts to a tolerance length.

4. The exhaust-gas turbocharger as claimed in claim 1, wherein the covering surface at least one of defines at least one straight edge and the covering surface defines at least two straight edges.

5. (canceled)

6. The exhaust-gas turbocharger as claimed in claim 4, wherein one straight edge of the covering surface is situated at a covering-surface end facing the axis of rotation.

7. The exhaust-gas turbocharger as claimed in claim 1, wherein the covering surface is of triangular, rectangular, trapezoidal, elliptical or diamond shape.

8. The exhaust-gas turbocharger as claimed in claim 1, wherein the covering surface defines a projection, which extends into the wastegate opening during closure.

9. The exhaust-gas turbocharger as claimed in claim 1, wherein the sealing surface of the flap, the sealing surface surrounding the covering surface, is flat and parallel to the plane of the covering surface.

10. The exhaust-gas turbocharger as claimed in claim 1, wherein the sealing surface of the flap, said sealing surface surrounding the covering surface, slopes relative to the covering surface.

11. The exhaust-gas turbocharger as claimed in claim 1, wherein the sealing surface of the flap, said sealing surface surrounding the covering surface, is conical- or spherical-cap-shaped.

12. The exhaust-gas turbocharger as claimed in claim 1, wherein the covering surface has a projection which extends into the wastegate opening during closure.

13. The exhaust-gas turbocharger as claimed in claim 11, wherein the thickness of the projection increases with increasing distance from the axis of rotation, starting from the region of the wastegate flap closest to the axis of rotation.

14. The exhaust-gas turbocharger as claimed in claim 4, wherein at least one of: the at least one straight edge is parallel to the axis of rotation or encloses with the latter an angle which is less than 10 degrees, and the two edges are parallel to one another or enclose between them an angle which is less than 10 degrees.

15. The exhaust-gas turbocharger as claimed in claim 8, wherein the projection is configured to correspond to the wastegate opening to be covered.
